(19) United States
(12) Patent Application Publication
(10) Pub. No.: US 2026/0249605 A1
(43) Pub. Date: Aug. 27, 2026

(54) METHOD FOR MANUFACTURING LAMINATED FABRIC IN WHICH FABRIC AND KOREAN PAPER ARE LAMINATED

(71) Applicant: HANWON MS CORP., Pocheon-si, Gyeonggi-do (KR)

(72) Inventor: Woo-Han JEONG, Pocheon-si (KR)

(73) Assignee: HANWON MS CORP., Pocheon-si, Gyeonggi-do (KR)

(21) Appl. No.: 18/726,475

(22) PCT Filed: Jan. 12, 2023
(86) PCT No.: PCT/KR2023/000612

§ 371 Date: Jul. 3, 2024

(30) Foreign Application Priority Data
Jan. 14, 2022 (KR) 10-2022-0005723

(51) Int. Cl. B32B 38/18; B32B 5/02; B32B 29/02; B32B 37/12; B32B 37/20; B32B 38/00

(52) U.S. Cl. CPC B32B 38/18; B32B 5/024; B32B 29/02; B32B 37/12; B32B 37/20; B32B 2038/0052; B32B 2250/02

(57) ABSTRACT

A method for manufacturing a laminated fabric in which a fabric and Korean paper are laminated is provided. The method for manufacturing a laminated fabric in which a fabric and Korean paper are laminated may comprise: a pretreatment step of pretreating the fabric in a rolled state; and a lamination step of laminating the Korean paper to the pretreated fabric.

### TECHNICAL FIELD

The present invention relates to a method for manufacturing a laminated fabric in which a fabric and Korean paper are laminated, and more specifically, a method for manufacturing a laminated fabric in which a fabric and Korean paper are laminated, the method capable of manufacturing a strong laminated fabric with higher tensile strength than conventional Korean paper fabric by continuously bonding a reinforcement and Korean paper without intermediate processes such as drying to a fabric that has undergone a pretreatment step such as dust removal, and performing post-treatment such as heat drying, etc.

### BACKGROUND ART

In general, Korean paper is made from the bark of a paper mulberry and thus is tough, soft to the touch, good at breathability and warmth, so it is used in various industrial fields such as wrapping paper or window paper as a natural material.

However, Korean paper itself has a low tensile strength and has the problem of being easily torn and deformed when submerged due to the nature of a paper material. In order to overcome these problems of Korean paper, there are various attempts, such as using Korean paper and fabric combined.

As an example, Korean Registered Patent No. 10-1524417 relates to a fabric manufacturing method that facilitates mass production by laminating Korean paper and fabric wound in rolls through automated machine work and produces a fabric with a leather-like texture and shape, and describes a configuration including a lamination step of combining Korean paper and fabric wound in a roll form; and a coating step of applying a coating agent to the laminated Korean paper and fabric.

However, according to Korean Registered Patent No. 10-15244416, since it is necessary to combine Korean paper and fabric and go through a separate adhesive drying period and fabric aging period, there is a problem in that productivity decreases due to a long working period. Further, although the fastness has increased compared to existing Korean paper, there is a problem that the Korean paper fabric manufactured by bonding Korean paper and fabric may be separated or peeled off.

In addition, the existing method of manufacturing Korean paper fabric often uses oil-based adhesives, which raises concerns about environmental pollution and has problems that can have a negative impact on the human body. Even if the Korean paper and fabric are bonded using a water-based adhesive rather than an oil-based adhesive, there is a problem that the Korean paper gets wet by the water-based adhesive and becomes wrinkled, an excessive drying period is required, and even the Korean paper is torn and damaged during the drying process.

Therefore, in order to solve these problems, there is a gradually growing need in the art for a method of manufacturing a laminated fabric in which fabric and Korean paper are laminated, the method capable of increasing the tensile strength of the laminated fabric by laminating a reinforcement to the fabric and Korean paper, shortening the working time by performing the reinforcement lamination process and the Korean paper lamination process continuously without a separate drying or aging period, further strengthening the adhesive strength by interpenetrating and mixing the adhesive between the reinforcement and the fabric and the adhesive between the Korean paper and the reinforcement, and preventing the wrinkling characteristic of Korean paper soaked in water-based adhesive and greatly shortening the drying period by thermal drying through a heat cylinder.

### DISCLOSURE

### Technical Problem

The present invention has been made to solve the above problems, and an object of the present invention is to provide a method of manufacturing a laminated fabric in which fabric and Korean paper are laminated, the method capable of manufacturing a laminated fabric having higher tensile strength as well as higher fastness than conventional laminated fabrics by laminating a reinforcement to the fabric and Korean paper.

In addition, another object of the present invention is to provide a method of manufacturing a laminated fabric in which fabric and Korean paper are laminated, the method capable of shortening the working time and improving productivity by performing the reinforcement lamination process and the Korean paper lamination process continuously without a separate drying or aging period.

Further, still another object of the present invention is to provide a method of manufacturing a laminated fabric in which fabric and Korean paper are laminated, the method capable of producing a laminated fabric in which the adhesive between the reinforcement and the fabric and the adhesive between the Korean paper and the reinforcement are interpenetrated and mixed, thereby further strengthening the adhesive strength compared to existing laminated fabrics and preventing the laminated paper from separating or peeling.

In addition, yet another object of the present invention is to provide a method of manufacturing a laminated fabric in which fabric and Korean paper are laminated, the method capable of preventing the wrinkling characteristic of Korean paper soaked in water-based adhesive and omitting or greatly shortening separate drying and aging periods by performing the reinforcement lamination process and the Korean paper lamination process continuously without a separate drying or aging period and thermal drying through a heat cylinder.

The technical objects of the present invention are not limited to the above-mentioned objects, and other technical objects not mentioned will be clearly understood by those skilled in the art from the following description.

### Technical Solution

In order to solve the above technical problems, a method for manufacturing a laminated fabric in which a fabric and Korean paper are laminated according to an embodiment of the present invention may include: a pretreatment step of pretreating the fabric in a rolled state; and a lamination step of laminating the Korean paper to the pretreated fabric.

In addition, the pretreatment step may include a rolling step of removing dust from the fabric in a rolled state using a rolling machine equipped with a dust collector and simultaneously rolling the dust-removed fabric.

In addition, the lamination step may include: a reinforcement lamination step of laminating a reinforcement to the fabric; and a Korean paper lamination step of laminating the Korean paper to the fabric to which the reinforcement is laminated.

In addition, a post-treatment step of post-treating the fabric to which the Korean paper is laminated may be further included.

In addition, the post-treatment step may include a heat drying step of heat-drying the fabric to which the Korean paper is laminated.

In addition, the post-treatment step may include a dust removal step of removing dust from the fabric to which the Korean paper is laminated.

In addition, a coating step of applying a coating agent to the Korean paper-laminated fabric that has been subjected to the post-treatment may be further included.

### Advantageous Effects

The method of manufacturing a laminated fabric in which fabric and Korean paper are laminated according to an embodiment of the present invention can manufacture a laminated fabric having higher tensile strength as well as higher fastness than conventional laminated fabrics by laminating a reinforcement to the fabric and Korean paper.

In addition, the method of manufacturing a laminated fabric in which fabric and Korean paper are laminated according to an embodiment of the present invention can shorten the working time and improve productivity by performing the reinforcement lamination process and the Korean paper lamination process continuously without a separate drying or aging period.

Further, the method of manufacturing a laminated fabric in which fabric and Korean paper are laminated according to an embodiment of the present invention is capable of producing a laminated fabric in which the adhesive between the reinforcement and the fabric and the adhesive between the Korean paper and the reinforcement are interpenetrated and mixed, thereby further strengthening the adhesive strength compared to existing laminated fabrics and preventing the laminated paper from separating or peeling.

In addition, the method of manufacturing a laminated fabric in which fabric and Korean paper are laminated according to an embodiment of the present invention is capable of preventing the wrinkling characteristic of Korean paper soaked in water-based adhesive and omitting or greatly shortening separate drying and aging periods by performing the reinforcement lamination process and the Korean paper lamination process continuously without a separate drying or aging period and thermal drying through a heat cylinder.

### DESCRIPTION OF DRAWINGS

In order to more fully understand the drawings cited in the detailed description of the present invention, a brief description of each drawing is provided.

FIG. 1 is a schematic flow chart for explaining a method (S10) for manufacturing a laminated fabric in which a fabric and Korean paper are laminated according to an embodiment of the present invention.

FIG. 2 is a schematic flow chart for explaining the pretreatment step (S100) according to an embodiment of the present invention.

FIG. 3 is a schematic flow chart for explaining a lamination step (S200) according to an embodiment of the present invention.

FIG. 4 is a schematic flow chart for explaining each detailed step of the lamination step (S200) according to an embodiment of the present invention.

FIG. 5 is a schematic flowchart for explaining a post-treatment step (S300) according to an embodiment of the present invention.

### BEST MODES OF THE INVENTION

Hereinafter, embodiments according to the present invention will be described with reference to the accompanying drawings. In adding reference numerals to the components of each drawing, it should be noted that the same components have the same numerals as much as possible, even if they are shown in different drawings. In addition, in describing an embodiment of the present invention, if it is determined that a detailed description of a related known configuration or function hinders the understanding of the embodiment of the present invention, the detailed description thereof will be omitted. In addition, embodiments of the present invention will be described below, but the technical idea of the present invention is not restricted or limited thereto and can be modified and implemented in various ways by those skilled in the art.

Throughout the specification, when it is said that a part is “connected” to another part, this includes not only cases where they are “directly connected,” but also cases where they are “indirectly connected” with another element interposed therebetween. Throughout the specification, when a part is described as “including” a certain component, it means that other components may be further included, rather than excluded, unless otherwise stated. In addition, terms such as first, second, A, B, (a), and (b) may be used to describe components of an embodiment of the present invention. These terms are only intended to distinguish the component from other components and do not limit the nature, order, or sequence of the component.

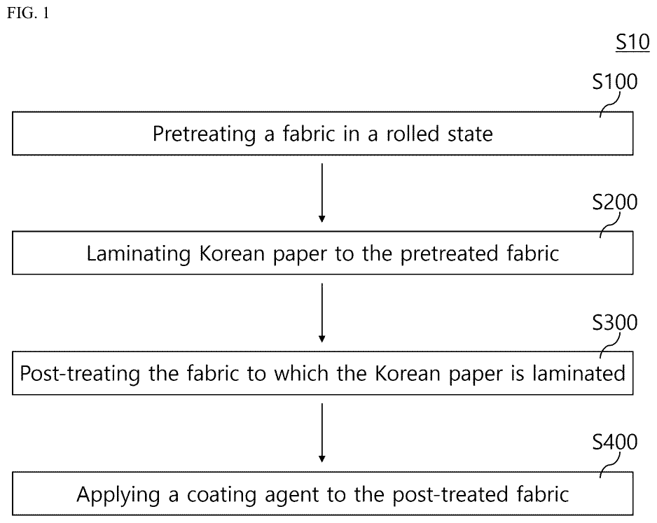

FIG. 1 is a schematic flow chart for explaining a method (S10) for manufacturing a laminated fabric in which a fabric and Korean paper are laminated according to an embodiment of the present invention.

The method (S10) for manufacturing a laminated fabric in which a fabric and Korean paper are laminated according to an embodiment of the present invention may include: a pretreatment step (S100) of pretreating the fabric in a rolled state, a lamination step (S200) of laminating Korean paper to the pretreated fabric, and a post-treatment step (S300) of post-treating the fabric to which the Korean paper is laminated.

In addition, the method (S10) for manufacturing a laminated fabric in which a fabric and Korean paper are laminated according to an embodiment of the present invention may further include a coating step (S400) of applying a coating agent to the Korean paper-laminated fabric that has been subjected to the post-treatment.

For reference, the fabric may include natural fibers such as cotton, hemp, wool, silk, or rayon, and is preferably composed of thick yarn and woven into a strong tissue. Accordingly, the laminated fabric manufactured by laminating the fabric made of natural fibers and the Korean paper can be harmless to the human body, and can fundamentally compensate for the low tensile strength of the Korean paper, making it a tougher material.

However, the configuration in which the fabric used in the laminated fabric manufacturing method (S10) according to an embodiment of the present invention is made of natural fibers is only an example for easy understanding of the present invention, and of course, configurations made of artificial fibers such as polyester as well as natural fibers are also included in an embodiment of the present invention.

In addition, according to an additional embodiment of the present invention, the fabric used in the laminated fabric manufacturing method (S10) may be a fabric woven by using a mulberry yarn extracted from a paper mulberry as a weft yarn and a pulp yarn a warp yarn. Of course, a fabric woven with the mulberry yarn as a warp yarn and the pulp yarn as a weft yarn may be used. For reference, the pulp yarn may refer to a yarn in which the bark of a paper mulberry is made into fiber.

In addition, the Korean paper used in the laminated fabric manufacturing method (S10) according to an embodiment of the present invention may be a paper material that can be made of a paper mulberry, and such Korean paper may be referred to as ‘mulberry paper’. In addition, the Korean paper used in the laminated fabric manufacturing method (S10) according to an embodiment of the present invention may include Jeo-wa paper, Baeg-taeg paper, Baeg-myeon paper, etc., which are classified by material, and may also include Seol-hwa paper (snowy paper), Baeg-lo paper (white heron paper), Jug-cheong paper (bamboo green paper), etc., which are classified by color. In addition, all of Korean papers having various colors dyed with dyes may be used.

First, the method (S10) for manufacturing a laminated fabric in which a fabric and Korean paper are laminated according to an embodiment of the present invention may include a pretreatment step (S100) of pretreating the fabric in a rolled state.

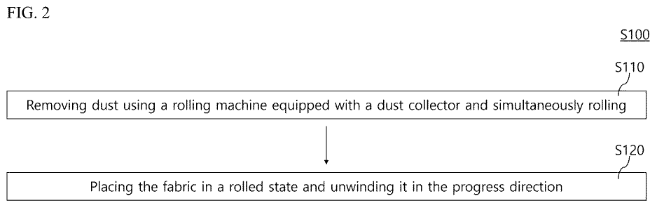

More specifically, referring to FIG. 2, the pretreatment step (S100) according to an embodiment of the present invention may include: a rolling step (S110) of removing dust from the fabric in a rolled state using a rolling machine equipped with a dust collector and simultaneously rolling the dust-removed fabric, and an unwinding step (S120) of placing the fabric in a rolled state and unwinding it in the progress direction.

More specifically, according to the rolling step (S110) according to an embodiment of the present invention, the fabric in a rolled state is placed in one area of a rolling machine equipped with a dust collector and the rolling machine is operated, whereby one end of the fabric in a rolled state moves according to the operation of the rolling machine, and the fabric in a rolled state can be unwound.

Subsequently, the fabric in a rolled state is unwound and passes through a dust collection area of the dust collector provided in one area of the rolling machine (e.g., a lower area of the rolling machine), and as the fabric passes through the dust collection area of the dust collector, dust, dirt, etc. on the surface of the fabric can be sucked in and removed through the dust collector. In addition, the fabric in a rolled state may be rolled again around one axis of the fabric roll by the rolling machine and returned to the rolled state.

That is, the rolling step (S110) according to an embodiment of the present invention is a step that may be performed before the fabric is unwound (S120) and transferred to a laminating apparatus implementing the lamination step (S200). A mechanical device implementing the rolling step (S110), that is, the rolling machine equipped with a dust collector, may be arranged separately from a device implementing the unwinding step (S120) of the fabric and/or a device implementing the lamination step (S200), or may be arranged and connected adjacent thereto.

Then, according to the unwinding step (S120) according to an embodiment of the present invention, the fabric in a rolled state, which has been subjected to the rolling step (S110) to remove dust and to be rolled, is placed on a rolled fabric holder provided in one area of the winder, and the winder is operated to unwind the fabric in a rolled state in the direction of movement.

In addition, a brake may be provided in one region of the winder that implements the unwinding step (S120), and the pressure intensity of the brake can be adjusted to control the progress speed of the unwinding fabric depending on the thickness or softness of the unwinding fabric. Accordingly, it is possible to prevent the fabric from being chewed or pushed due to excessively fast moving speed of the fabric.

In addition, if the fabric in a rolled state is not unwound to a certain area in the unwinding step (S120), the fabric may be chewed. Therefore, by manually (or automatically using a sensor) adjusting the position of the rolled fabric holder on which the fabric in a rolled state is placed, the fabric in a rolled state can be unwound to a certain area.

In addition, an additional dust collector may be provided in at least a portion of the areas where the fabric is unwound, and thus dust removal from the unwound fabric can be performed again. That is, the dust removal from the fabric may be performed primarily in the rolling step (S110), and the dust removal from the fabric may be secondarily performed in the unwinding step (S120), so that a total of two dust removals may be performed in the pretreatment step (S100). Accordingly, the quality of the laminated fabric to be manufactured can be improved and the defect rate can be extremely low.

However, the configuration in which the dust removal is performed twice in the pretreatment step (S100) according to an embodiment of the present invention is only an example for easy understanding of the present invention, and of course, configurations in which the dust removal is performed once or three times or more are also included in an embodiment of the present invention.

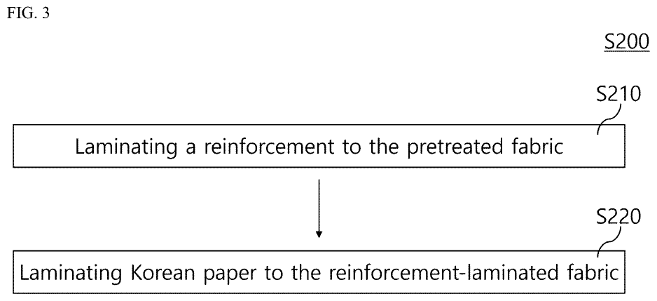

Next, referring to FIG. 3, the method (S10) for manufacturing a laminated fabric in which a fabric and Korean paper are laminated according to an embodiment of the present invention may include a lamination step (S200) of laminating Korean paper to the pretreated fabric, wherein the lamination step (S200) according to an embodiment of the present invention may include a reinforcement lamination step (S210) of laminating a reinforcement to the fabric, and a Korean paper lamination step (S220) of laminating Korean paper to the fabric to which the reinforcement is laminated.

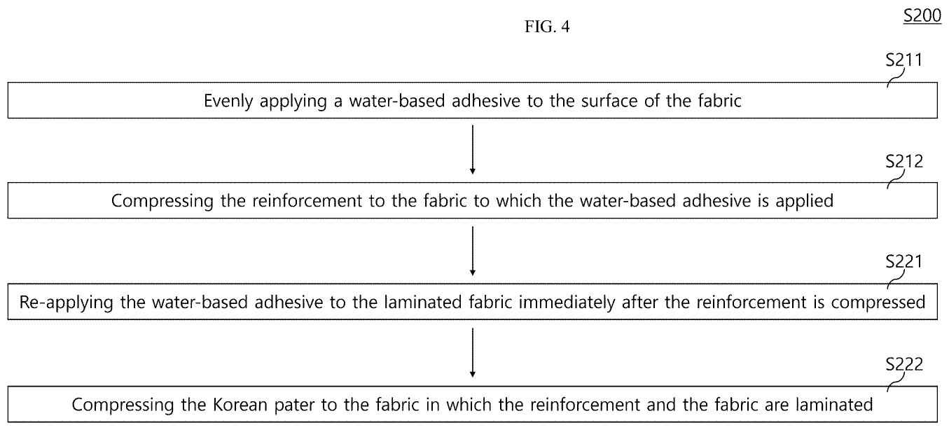

Referring to FIG. 4, according to the reinforcement lamination step (S210) according to an embodiment of the present invention, a water-based adhesive may be applied on the surface of the fabric that is unwound through the pretreatment step (S100) and moves in the direction of progress through the automatic transfer means (S211), and a reinforcement may be pressed on the surface of the fabric to which the water-based adhesive is applied (S212). That is, the reinforcement lamination step (S210) according to an embodiment of the present invention may include a first adhesive application step (S211) of applying the water-based adhesive to the surface of the fabric, and a first pressing step (S212) of compressing the reinforcement to the fabric to which the water-based adhesive is applied.

More specifically, according to the first adhesive application step (S211) according to an embodiment of the present invention, the water-based adhesive may be evenly applied through the application means to the entire surface of the fabric unwound by the winder and moving in the progress direction by the automatic transfer means. The application means for applying the water-based adhesive may be composed of a mesh member (for example, a mesh roller), and thus the water-based adhesive may pass through a filtering net of the mesh member and be applied to the surface of the fabric. In addition, the number of eyes of the mesh member may vary depending on the thickness of the fabric.

For example, the number of eyes of the mesh member for applying the adhesive may be variously provided within a numerical range of 20 to 70 eyes, and the aqueous adhesive may be applied to the surface of the fabric by replacing the mesh member having an appropriate number of eyes depending on the thickness of the fabric.

In addition, the mesh roller for applying the water-based adhesive in the first adhesive application step (S211) may be configured to engage with other rollers, and the water-based adhesive may be applied to the surface of the fabric as the fabric transported by the automatic transfer means passes between the mesh roller for applying the water-based adhesive and the roller engaged with it. For reference, the mesh roller may be made of a metal material (e.g., steel, iron, etc.), and the automatic transfer means for moving the fabric may include a plurality of guide rollers.

In addition, the mesh roller for applying the water-based adhesive may be disposed below another rubber material roller engaged with the mesh roller, and the fabric passing between the two rollers can be pressed as the rubber roller placed above the mesh roller presses in the downward direction. For reference, the degree of pressure applied to the fabric passing between the mesh roller and another rubber material roller engaged with the mesh roller may be differently adjusted depending on the thickness, material, and the like of the fabric. That is, the pressure acting on the fabric can be adjusted by adjusting the degree of force applied by the rubber roller engaged with the mesh roller in the downward direction.

For reference, the adhesive applied in the first adhesive application step (S211) according to an embodiment of the present invention is a water-based adhesive, which is less likely to cause environmental pollution compared to oil-based adhesives and thus eco-friendly, and may be harmless to the human body. For example, the water-based adhesive may be water-based polyurethane and water-based matte or glossy laminating coating agent, but is not limited thereto.

Then, the reinforcement may be compressed and laminated to the fabric to which the water-based adhesive is applied (S212). That is, the fabric to which the water-based adhesive is applied is transferred to the compression means by the automatic transfer means including a plurality of guide rollers, and the reinforcement may be compressed on the surface of the fabric to which the water-based adhesive is applied.

More specifically, the reinforcement may be provided in a rolled state above the compression means, wherein the reinforcement in a rolled state may be unwound in a downward direction according to the operation of the winder, and the unwound reinforcement may be transferred to the compression means along a plurality of guide rollers and compressed on the surface to which the adhesive is applied.

In addition, for example, the compression means may be composed of a pair of rubber rollers that engage with each other, and the reinforcement can be compressed on the fabric as the adhesive-applied fabric transferred by the automatic transfer means and the reinforcement transferred by the automatic transfer means from the top are rolled between a pair of engaging rubber rollers. Accordingly, the adhesive-applied fabric and the reinforcement can be laminated.

In addition, the degree of pressure applied by the compression means composed of a pair of rubber rollers to the fabric and reinforcement compressed between the pair of engaging rubber rollers may be adjusted depending on the type and thickness of fabric, type of reinforcement, or the like.

In addition, a separate pressure brake may be provided in the unwinder for unwinding the reinforcement and/or the automatic transfer means for transferring the reinforcement to the compression means, and the pressure brake may be adjusted according to the type and thickness of fabric, type of reinforcement, etc. to control the speed at which the reinforcement advances to the compression means and the speed at which it passes through the compression means.

For reference, the reinforcement used in the reinforcement lamination step (S210) may include reinforcements made of various materials such as film, nonwoven fabric, Korean paper, and fabric.

Immediately after going through the reinforcement lamination step (S210) of laminating the reinforcement to the fabric as described above, the Korean paper lamination step (S220) may be performed continuously. That is, since the water-based adhesive is applied to the fabric, the fabric laminated with the reinforcement is wet by the water-based adhesive. In general, since the laminated fabric using a water-based adhesive is wet by the water-based adhesive, it must go through a separate long drying and aging step. If this step is not performed, the laminated fabric does not dry and has the side effect of becoming wrinkled.

However, according to the method (S10) for manufacturing a laminated fabric in which a fabric and Korean paper are laminated according to an embodiment of the present invention, the Korean paper lamination step (S220) may be continuously performed immediately after the reinforcement lamination step (S210) for laminating the reinforcement to the fabric without going through a separate drying and/or aging step between the reinforcement lamination step (S210) and the Korean paper lamination step S220, thereby shortening the working time and thus improving productivity.

That is, according to the Korean paper lamination step (S220) according to an embodiment of the present invention, immediately after the reinforcement and the fabric are laminated, and before the water-based adhesive applied to the reinforcement-laminated fabric is dried, the reinforcement-laminated fabric is transferred by the automatic transfer means to a water-based adhesive application means that is mechanically connected to the reinforcement lamination means, and the water-based adhesive may be secondarily applied to the surface of the reinforcement-laminated fabric (S221). The fabric and Korean paper can be laminated by pressing the Korean paper onto the reinforcement-laminated fabric to which water-based adhesive has been applied secondarily (S222).

In other words, the Korean paper lamination step (S220) according to an embodiment of the present invention may include a secondary adhesive application step (S221) of re-applying the water-based adhesive to the fabric to which the reinforcement is laminated, and a secondary pressing step (S222) of compressing the Korean pater to the reinforcement-laminated fabric to which the water-based adhesive is re-applied.

More specifically, according to the secondary adhesive application step (S221) according to an embodiment of the present invention, the reinforcement-laminated fabric moves in the progress direction by the automatic transfer means, and the water-based adhesive may be uniformly applied to the entire surface through the application means as in the first adhesive application step (S211).

Similar to the first adhesive application step (S211), the application means used in the secondary adhesive application step (S221) may be composed of a mesh member, that is, a mesh roller, and thus the water-based adhesive may pass through a filtering net of the mesh roller and be applied to the surface of the laminated fabric. However, in the secondary adhesive application step (S221), the water-based adhesive may be applied to the surface on the reinforcement side of the reinforcement-laminated fabric. The number of eyes of the application means composed of a mesh member may vary depending on the thickness of the fabric to be laminated. For example, the number of eyes of the mesh member, i.e., mesh roller, for applying the adhesive may be variously provided within a numerical range of 20 to 70 eyes, and the aqueous adhesive may be applied by replacing the mesh roller having an appropriate number of eyes depending on the thickness of the fabric.

In addition, the mesh roller for applying the water-based adhesive in the secondary adhesive application step (S221) may be configured to engage with other rollers, and the water-based adhesive may be applied to the surface of the reinforcement-laminated fabric as the fabric transported by the automatic transfer means passes between the mesh roller for applying the water-based adhesive and the rubber roller engaged with it. For reference, the mesh roller for applying the water-based adhesive on the surface of the fabric to which the reinforcement is laminated may be made of a metal material (e.g., steel, iron, etc.).

In addition, the mesh roller for applying the water-based adhesive may be disposed below another rubber material roller engaged with the mesh roller, and the fabric passing between the mesh roller and the roller engaged with the mesh roller can be pressed as the mesh roller and the rubber roller engaged with the mesh roller presses in the downward direction.

For reference, the degree of pressure applied to the fabric passing between the mesh roller and another roller engaged with the mesh roller may be differently adjusted depending on the thickness, material, and the like of the fabric. That is, the pressure acting on the fabric can be adjusted by adjusting the degree of force applied by the roller disposed above the mesh roller in the downward direction.

For reference, the water-based adhesive applied in the secondary adhesive application step (S221) according to an embodiment of the present invention may be the same as the water-based adhesive used in the first adhesive application step (S211). However, the type of water-based adhesive used may be different depending on the type, material, thickness, etc. of the Korean paper to be laminated to the reinforcement-laminated fabric, and thus, the types of water-based adhesive used in the first adhesive application step (S211) and the water-based adhesive used in the secondary adhesive application step (S221) may also be different.

Then, the Korean paper may be compressed and laminated to the reinforcement-laminated fabric to which the water-based adhesive has been applied (S222). That is, the reinforcement-laminated fabric to which the water-based adhesive is applied may be transferred to the compression means by the automatic transfer means including a plurality of guide rollers immediately after the reinforcement is laminated, and the Korean paper may be compressed on the surface of the reinforcement-laminated fabric to which the water-based adhesive is applied, that is, on the surface of the reinforcement. Accordingly, a laminated fabric with a three-layer structure can be manufactured in which the fabric is compressed and laminated on one side of the reinforcement, and the Korean paper is compressed and laminated on the other side.

The Korean paper may be provided in a rolled state above the compression means, wherein the Korean paper in a rolled state may be unwound in a downward direction according to the operation of the winder, and the unwound Korean paper may be transferred to the compression means along a plurality of guide rollers and compressed on the surface to which the water-based adhesive is applied.

In addition, for example, the compression means may be composed of a pair of rubber rollers that engage with each other, and the Korean paper can be compressed on the reinforcement-laminated fabric as the water-based adhesive-applied fabric transferred by the automatic transfer means and the Korean paper transferred by the automatic transfer means from the top are rolled between a pair of engaging rubber rollers. Accordingly, the laminated fabric in which the fabric, the reinforcement, and the Korean paper are sequentially laminated can be manufactured.

In addition, the degree of pressure applied by the compression means composed of a pair of rubber rollers to the fabric and reinforcement compressed between the pair of engaging rubber rollers may be adjusted depending on the type and thickness of fabric, type of Korean paper, or the like.

In addition, a separate pressure brake may be provided in the unwinder for unwinding the Korean paper and/or the automatic transfer means for transferring the Korean paper to the compression means, and the pressure brake may be adjusted according to the type and thickness of fabric, type of Korean paper, temperature, humidity, etc. to control the speed at which the Korean paper advances to the compression means and the speed at which it passes through the compression means.

The lamination step (S200) according to an embodiment of the present invention is divided into the reinforcement lamination step (S210) and the Korean paper lamination step (S220) and is performed continuously without going through a separate drying and aging period between the steps. Accordingly, while the water-based adhesive between the fabric and the reinforcement in the reinforcement lamination step (S210) is not dried, the water-based adhesive is applied secondarily between the reinforcement and the Korean paper in the Korean paper lamination step (S220), whereby the water-based adhesive between the fabric and the reinforcement and the water-based adhesive between the reinforcement and the Korean paper can penetrate into the reinforcement located in the middle and mix with each other. As a result, the bonding strength between the fabric, the reinforcement, and the Korean paper can be greatly improved, preventing the manufactured laminated fabric from being separated or peeled off.

According to a further embodiment of the present invention, the compression means used in the first compression step (S212) and/or the secondary compression step (S222) may be composed of a thermal compression means. More specifically, the fabric to be laminated is transferred by the automatic transfer means and passed between a pair of pressing rollers to compress it and at the same time apply high heat (for example, 80 to 90° C.) thereto, whereby the adhesion as well as the bonding strength between the fabric, the reinforcement, and the Korean paper is increased, thereby preventing peeling or separation.

In addition, according to an additional embodiment of the present invention, the reinforcement lamination step (S210) and the Korean paper lamination step (S220) may be performed simultaneously. More specifically, the water-based adhesive may be applied to both sides of the reinforcement, and the pretreated fabric may be compressed on one side of the reinforcement in which the water-based adhesive is applied to both sides, and at the same time, the Korean paper may be compressed on the other side of the reinforcement, thereby manufacturing a three-layer laminated fabric. Accordingly, the overall working time can be shortened, and the mixing effect through interpenetration of the water-based adhesive into the reinforcement can be improved, thereby further improving adhesion.

Then, the method (S10) for manufacturing a laminated fabric in which a fabric and Korean paper are laminated according to an embodiment of the present invention may further include a post-treatment step (S300) of post-treating the fabric to which the Korean paper is laminated.

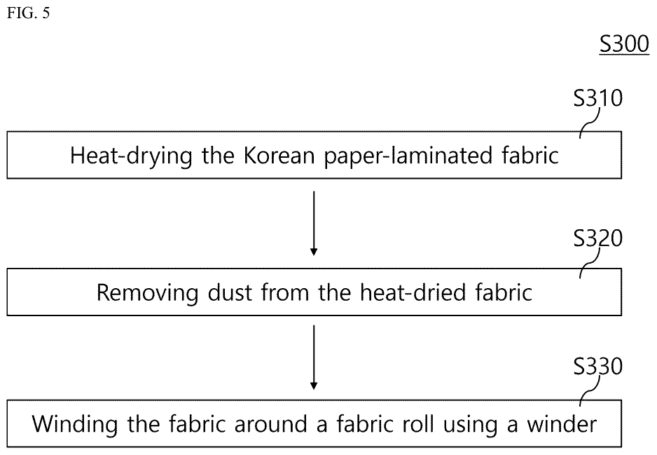

Referring to FIG. 5, the post-treatment step (S300) according to an embodiment of the present invention may include a heat drying step (S310) of heat-drying the Korean paper-laminated fabric, a dust removal step (S320) of removing dust from the Korean paper-laminated fabric, and a winding step (S330) of winding the laminated fabric that has been heat-dried (and dust-removed) around a fabric roll using a winder.

First, in the heat drying step (S310) of heat-drying the Korean paper-laminated fabric, the fabric to which the Korean paper and the reinforcement are laminated may be drawn into a heat cylinder by an automatic transfer means, heat-dried through the heat cylinder, and drawn out of the heat cylinder.

More specifically, according to the heat drying step (S310) according to an embodiment of the present invention, a plurality of (e.g., three) rotary cylinders may be provided inside the heat cylinder, wherein the plurality of rotary cylinders may be alternately arranged to an upper side and a lower side. The fabric having a three-layered structure in which the Korean paper and reinforcements are laminated may be introduced into the heat cylinder by the automatic transfer means, alternately wound around the plurality of cylindrical rotary cylinders, and move in the progress direction according to the rotation of the rotary cylinder to be drawn out of the heat cylinder.

To explain further in detail, the plurality of cylindrical rotary cylinders may be provided inside the heat cylinder in the heat drying step (S310), and the cylindrical surfaces of the plurality of rotary cylinders may be configured to generate heat, wherein the laminated fabric can be wound alternately and sequentially around the plurality of rotary cylinders so that the heat-generating outer surface of the rotary cylinder and the laminated fabric can be in close contact, and the laminated fabric wound around the rotary cylinder may also rotate according to the rotation of the rotary cylinder and be transferred in the progress direction to be drawn out of the heat cylinder.

Accordingly, the laminated fabric in close contact with the rotary cylinder inside the heat cylinder can be dried (and aged) in a state containing an appropriate amount of moisture without being wrinkled due to the ironing effect. For heat drying through the heat cylinder, preferably, the internal humidity of the heat cylinder may be maintained at 40 to 60%, and the external surface temperature of the rotary cylinder may be appropriately adjusted between 70 and 130 degrees depending on the type and material of the fabric to be laminated, etc.

In the case of laminating the Korean paper and the fabric using the water-based adhesive, the laminated fabric contains excessive moisture, that is, the laminated fabric becomes wet, whereby there were problems that the quality of the laminated fabric may deteriorate due to the surface becoming wrinkled during the drying process, and the drying and aging period may also be prolonged, leading to a decrease in productivity. However, in the method (S10) of manufacturing a laminated fabric in which the fabric and Korean paper are laminated according to an embodiment of the present invention, the lamination step (S200) is divided into the reinforcement lamination step (S210) and the Korean paper lamination step (S220) wherein the two steps are carried out continuously, and the heat drying step (S310) is performed through the heat cylinder, whereby productivity can be greatly improved by omitting a separate drying step, and the quality of the laminated fabric can also be greatly improved due to the ironing effect of the heat cylinder.

Through the heat drying step (S310) using the heat cylinder, the laminated fabric does not become wrinkled and can be wound in the winding step (S330) while retaining an appropriate amount of moisture, whereby it is possible to prevent a tearing phenomenon of the laminated fabric that may occur when the fabric is wound in an excessively dried state.

Subsequently, dust removal may be finally performed on the laminated fabric that has undergone the heat drying step (S310) according to an embodiment of the present invention (S320). More specifically, the laminated fabric drawn out of the heat cylinder may be transported to the fabric roll by an automatic transfer means, and a dust collector may be provided in at least a portion of the transported area to remove dust on the surface of the laminated fabric.

Then, the laminated fabric, which has been heat-dried and dust-removed, may be wound around a fabric roll (S330). More specifically, the laminated fabric from which dust has been removed may be moved to the fabric roll by the automatic transfer means and wound around the fabric roll according to the operation of the winder.

In addition, the position of the fabric roll itself on which the laminated fabric is wound can be adjusted by manually or automatically moving the holder of the fabric roll itself so that the laminated fabric can be wound to a certain area in the winding step (S330), whereby it is possible to prevent the laminated fabric from being chewed in the direction of progress during the winding process.

In addition, unlike a common roll-type holder that freely rotates, the winding machine, which implements winding of the laminated fabric, can be equipped with a pressure brake, and thus can adjust the rotational speed of the fabric roll, thereby preventing the laminated fabric from being damaged due to chewing, folding, and wrinkles during the winding process.

According to an additional embodiment of the present invention, the speed of the fabric by the device implementing each of the steps (S100, S200, S300) in the method (S10) of manufacturing a laminated fabric in which the fabric and Korean paper are laminated may be the same, but the working time of each of the steps (S100, S200, and S300) need to be different as necessary, for example, the time taken in the heat drying step (S310) may be greater than the time taken in the pretreatment step (S100). Accordingly, the present invention may further include a step of adjusting the progress speed of the fabric between the respective steps (S100, S200, and S300) by providing a separate device for adjusting the progress speed of the fabric between the devices implementing the respective steps (S100, S200, and S300).

Further, according to an additional embodiment of the present invention, it may further include a cooling step of cooling the fabric that has undergone heat drying after the heat drying step (S310). For example, the laminated fabric to which high heat has been applied may be drawn out of the heat cylinder, transferred by an automatic transfer means, and quenched by passing through a cooler, thereby making the bonding strength between the laminated Korean paper, fabric, and reinforcement more solid and strong.

In addition, the method (S10) for manufacturing a laminated fabric in which a fabric and Korean paper are laminated according to an embodiment of the present invention may further include a coating step (S400) of applying a coating agent to the Korean paper-laminated fabric that has been subjected to the post-treatment. That is, the Korean paper-laminated fabric wound around the fabric roll may go through a predetermined drying and/or aging period as necessary, and then be unwound again to apply a coating agent to the surface.

Here, the coating agent may be preferably a mixture of at least one of materials having waterproof function, water repellent function, moisture permeability function, gloss function or antibacterial function when coated on the fabric with vegetable oil or resin harmless to the human body, and more preferably the mixture further containing a material having a flame-retardant function, wherein the coating agent may have a property that does not bleed color after coating.

Accordingly, the laminated fabric manufactured through the coating step (S400) after laminating the Korean paper and the fabric may have waterproof and water repellent properties that can withstand a certain pressure of water, and at the same time may enjoy a moisture permeability effect of discharging internal water vapor to the outside, preventing Korean paper from being vulnerable to water and deforming its shape. Additionally, the laminated fabric can become glossy to create an aesthetic look for products made from the fabric, and can also have antibacterial and flame retardant properties.

The method (S10) of manufacturing a laminate fabric in which the fabric and Korean paper are laminated as described above may be suitable for mass production as a roll-to-roll production method. In addition, the method (S10) of manufacturing a laminate fabric in which the fabric and Korean paper are laminated may be divided into the pretreatment step (S100), lamination step (S200), post-treatment step (S300), and coating step (S400), and more specifically, the rolling step (S110), unwinding step (S120), first adhesive application step (S211), first compression step (S212), second adhesive application step (S221), second compression step (S222), heat drying step (S310), dust removal step (S320), winding step (S330) and coating step (S400). Each of these steps may be uniformly performed in one line or one factory, but is not limited thereto, and each step may be separated and separately performed in different lines or different factories rather than in one line.

As described above, the method of manufacturing a laminated fabric in which fabric and Korean paper are laminated according to an embodiment of the present invention can manufacture a laminated fabric having higher tensile strength as well as higher fastness than conventional laminated fabrics by laminating a reinforcement to the fabric and Korean paper.

In addition, the method of manufacturing a laminated fabric in which fabric and Korean paper are laminated according to an embodiment of the present invention can shorten the working time and improve productivity by performing the reinforcement lamination process and the Korean paper lamination process continuously without a separate drying or aging period.

Further, the method of manufacturing a laminated fabric in which fabric and Korean paper are laminated according to an embodiment of the present invention is capable of producing a laminated fabric in which the adhesive between the reinforcement and the fabric and the adhesive between the Korean paper and the reinforcement are interpenetrated and mixed, thereby further strengthening the adhesive strength compared to existing laminated fabrics and preventing the laminated paper from separating or peeling.

In addition, the method of manufacturing a laminated fabric in which fabric and Korean paper are laminated according to an embodiment of the present invention is capable of preventing the wrinkling characteristic of Korean paper soaked in water-based adhesive and omitting or greatly shortening separate drying and aging periods by performing the reinforcement lamination process and the Korean paper lamination process continuously without a separate drying or aging period and thermal drying through a heat cylinder.

As described above, the optimum embodiments have been disclosed in the drawings and specifications. Although specific terms have been used herein, they are only used for the purpose of describing the present invention and are not used to limit the meaning thereof or to limit the scope of the present invention described in the claims. Therefore, those of ordinary skill in the art will understand that various modifications and other equivalent embodiments are possible from the above. Therefore, the true technical scope of protection of the present invention should be determined by the technical spirit of the appended claims.

### DESCRIPTION OF REFERENCE NUMERALS AND SYMBOLS

S10: method for manufacturing a laminated fabric in which a fabric and Korean paper are laminated
S100: pretreatment step
S110: rolling step
S120: unwinding step
S200: lamination step
S210: reinforcement lamination step
S211: first adhesive application step
S212: first compression step
S220: Korean paper lamination step
S221: second adhesive application step
S222: second compression step
S300: post-treatment step
S310: heat drying step
S320: dust removal step
S330: winding step
S400: coating step

1. A method for manufacturing a laminated fabric in which a fabric and Korean paper are laminated, the method including:
a pretreatment step of pretreating the fabric in a rolled state; and
a lamination step of laminating the Korean paper to the pretreated fabric.

2. The method for manufacturing a laminated fabric in which a fabric and Korean paper are laminated according to claim 1,
wherein the pretreatment step includes a rolling step of removing dust from the fabric in a rolled state using a rolling machine equipped with a dust collector and simultaneously rolling the dust-removed fabric.

3. The method for manufacturing a laminated fabric in which a fabric and Korean paper are laminated according to claim 1,
wherein the lamination step includes:
a reinforcement lamination step of laminating a reinforcement to the fabric; and
a Korean paper lamination step of laminating the Korean paper to the fabric to which the reinforcement is laminated.

4. The method for manufacturing a laminated fabric in which a fabric and Korean paper are laminated according to claim 1,
wherein the method further includes a post-treatment step of post-treating the fabric to which the Korean paper is laminated.

5. The method for manufacturing a laminated fabric in which a fabric and Korean paper are laminated according to claim 4,
wherein the post-treatment step includes a heat drying step of heat-drying the fabric to which the Korean paper is laminated.

6. The method for manufacturing a laminated fabric in which a fabric and Korean paper are laminated according to claim 4,
wherein the post-treatment step includes a dust removal step of removing dust from the fabric to which the Korean paper is laminated.

7. The method for manufacturing a laminated fabric in which a fabric and Korean paper are laminated according to claim 4,
wherein the method further includes a coating step of applying a coating agent to the Korean paper-laminated fabric that has been subjected to the post-treatment.
